(19) United States
(12) Patent Application Publication
(10) Pub. No.: US 2009/0157221 A1
(43) Pub. Date: Jun. 18, 2009

(54) ROBOTIC SYSTEM, ROBOT AND MOBILE PHONE

(75) Inventor: KIM-YEUNG SIP, Shenzhen City (CN)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/331,375

(22) Filed: Dec. 9, 2008

(30) Foreign Application Priority Data
Dec. 14, 2007 (CN) 200710203073.0

(51) Int. Cl. G05B 19/02

(52) U.S. Cl. 700/245; 455/550.1; 901/50

(57) ABSTRACT

A robot includes a storage unit, a card, a wireless communication module, a center controller, action units, and drive units. The action units execute motions. The medium contains an electronic identifier to identify the robot. The storage unit stores predetermined motion control programs for control the action units to motion. The wireless communication module receives a text message from the mobile phone, the text message comprising a tag corresponding to one motion control program. A center controller invokes a corresponding one of predetermined motion control programs corresponding to the tag. The drive units drive the action units to motion under the control of the corresponding motion control program.

### BACKGROUND

1. Technical Field

The present disclosure generally relates to robotic systems, and particularly to a robot and a mobile phone for wirelessly controlling the robot.

2. Description of Related Art

Robots and other remote controlled devices are becoming more popular. At present, personal robots designed for performing work or entertainment are normally manipulated by wireless remote controllers, which may have limited effective range.

Generally, personal robots run a limited number of predetermined routines. They are not flexible enough to adapt to new routines and also they are not personalizable.

Therefore, a convenient and personalize robotic system is desired, and a related robot and a mobile phone of the robotic system are also desired.

Other advantages and novel features will become more apparent from the following detailed description of exemplary embodiments when taken in conjunction with the accompanying drawings.

### BRIEF DESCRIPTION OF THE DRAWINGS

FIG. 1 is a schematic diagram of a robotic system in accordance with an exemplary embodiment.

FIG. 2 is a functional block diagram of a wireless device in accordance with a first exemplary embodiment.

FIG. 3 is a functional block diagram of a robot in accordance with a first exemplary embodiment.

FIG. 4 is a functional block diagram of a wireless device in accordance with a second exemplary embodiment.

FIG. 5 is a functional block diagram of a robot in accordance with a second exemplary embodiment.

FIG. 6 is a table of roles and emotions of a robot in accordance with an exemplary embodiment.

### DETAILED DESCRIPTION

References will now be made to the drawings to describe exemplary embodiments of the present robotic system and robot and mobile phone thereof.

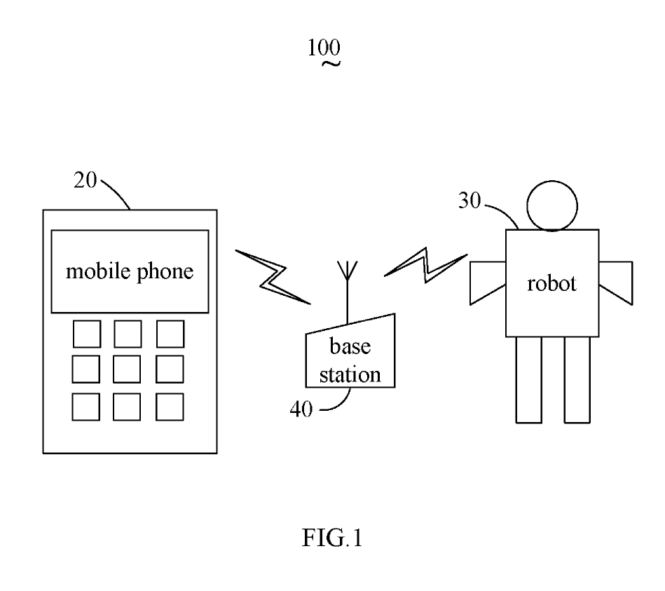

Referring to FIG. 1, a robotic system 100 includes a robot 30, a mobile phone 20, and a base station 40. The mobile phone 20 may be any device with mobile phone function, such as a personal digital assistant (PDA). The robot 30 has an electronic identifier, which is capable of being recognized by the mobile phone 20. The electronic identifier may be, for example, a phone number. The mobile phone 20 communicates with the robot 30 via the base station 40 with signals formatted for use with an already-existing messaging service, such as a short message service, multimedia messaging service or an E-mail service.

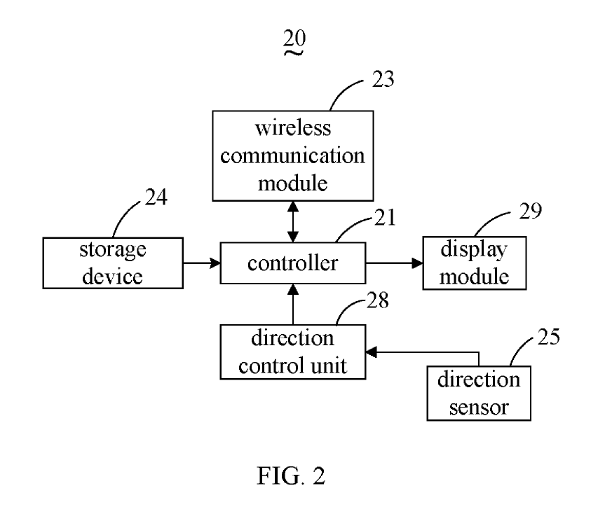

Referring to FIG. 2, a functional block diagram of the mobile phone 20 in accordance with a first exemplary embodiment is illustrated. The mobile phone 20 includes a storage device 24, a controller 21, a wireless communication module 23, a direction sensor 25, a direction control unit 28, and a display module 29.

The storage device 24 is configured for storing the electronic identifier of the robot 30 which enables the base station 40 to recognize the robot 30.

The direction sensor 25 may be any device which is capable of detecting direction of movement of the mobile phone 20, and generating direction data accordingly. In the embodiment, a tri-axis accelerator is used as the direction sensor 25. The direction data indicates a position shift of the mobile phone 20 and includes an X-axis acceleration, a Y-axis acceleration, and a Z-axis acceleration. The X-axis acceleration may indicate a left-right position shift quantity, the Y-axis acceleration may indicate a forward-backward position shift quantity, and the Z-axis acceleration may indicate a up-down position shift quantity of the communication device 20.

The direction control unit 28 is configured for generating a direction signal according to the direction data. The direction signal contains a tag corresponding to the X-axis, Y-axis, Z-axis for indicating the movement of the mobile phone 20. For example, the tag may have a combination of data such as “1: −2: −1” when motion of the mobile phone 20 is along all three axes. “1” could be used to indicate the mobile phone 20 has shifted along the X-axis by +1 meter. “−2” could be used to indicate the mobile phone 20 has shifted along the Y-axis by −2 meter. “−1” could be used to indicate the mobile phone 20 has shifted along the Z-axis by −1 meter. Each of several possible movements of the mobile phone 20 have a pre-established association with corresponding commands that are executable by motion control programs later described herein. The direction signals may be sent in short message format or in E-mail format.

The wireless communication module 23 is capable of communicating wirelessly with the robot 30 through the base station 40 using the SMS or E-mail formatted signals. The controller 21 is configured for receiving the electronic identifier of the robot 30 and controlling the wireless communication module 23 to transmit the direction signals to the robot 30. The controller 21 is further configured to present a robot option menu on command of a user on the display module 29. The menu may include different modes of operation of the robot 30. Such as a copy mode, wherein once selected communication with the robot 30 is started, the robot 30 will mimic the movements of the mobile phone 20 as described below.

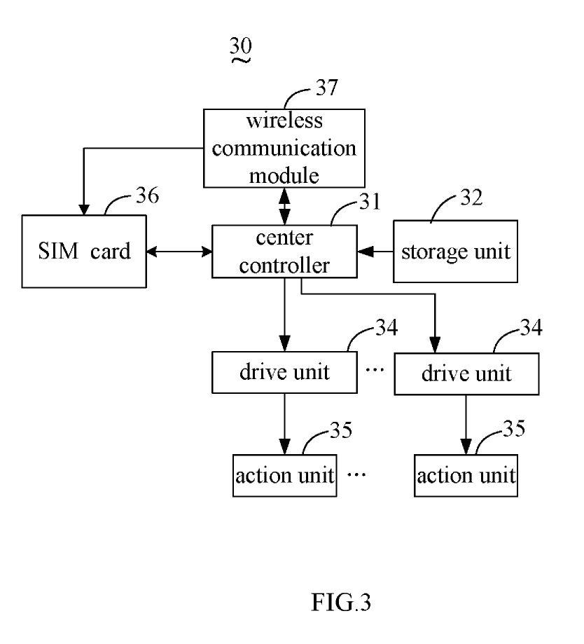

Referring also to FIG. 3, the robot 30 includes a subscriber identity module (SIM) card 36, a center controller 31, a storage unit 32, a plurality of drive units 34, a plurality of action units 35, and a wireless communication unit 37. The plurality of action units 35 may be limbs or other protuberances or parts of the robot 30, such as legs, arms, a head, a mouth, and a jointed section like a human knee. The plurality of drive units 34 are arranged to drive the plurality of action units 35 respectively.

The storage unit 32 stores motion control programs. Each motion control program is associated with a specific tag or tags for being invoked when that tag is received by the center controller 31 through the wireless communication module 37. Each motion control program defines different control parameters and relationships between the control parameters and the action units 35 to control motion of one or more action units 35. The control parameters correspond to the tag contained in the direction signal, and the motion control program executes the relationship between the parameters and the action units 35 via the data contained in the tag. For example, in response to a selected mode from the mobile phone 20, when the movement of the mobile phone 20 along the X-axis, one or more action units 35 may cooperate to change position or direction of travel of the robot 30 or cause the robot 30 to perform some tasks. In this way it is possible to have the robot 30 copy movements of the person holding and moving the mobile phone 20, or alternatively perform a specific task like laugh aloud when the user shakes the mobile phone 20 left and right. In this embodiment, if the data contained in the tag corresponding to the X-axis is +1 meter, one or more action units 35 may cause the robot 30 to move right by 1 meter. If the data corresponding to the X-axis is −1 meter, one or more action units 35 may cause the robot 30 to move left by 1 meter. Therefore, the motions of the robot 30 can be designed to be similar to the motions of the mobile phone 20 and thus the user.

The SIM card 36 is used for containing the electronic identifier of the robot 30. The wireless communication module 37 is capable of communicating with the mobile phone 20 to receive the direction signal.

The center controller 31 is configured for invoking a corresponding motion control program based on the tag received through the wireless communication module 37. One or more drive units 34 are arranged to drive corresponding action unit(s) 35 respectively under the control of the motion control program.

In use, when a user wants, for example, to directly control movements of the robot 30, the user may cause the robot 30 to go into the copy mode by selecting the corresponding option on the robot option menu of the mobile phone 20. Then to control the robot 30 to move left, right, forward or backward, the user can move the mobile phone 20 in corresponding directions on a horizontal plane. Likewise, when a user wants the robot 30 to jump up or down, the user need only move the mobile phone 20 vertically. Therefore, it is convenient for the user to manipulate the robot 30 even from a distance. Further, the robot 30 is capable of executing actions according to the movements of the mobile phone 20, which is more flexible than the conventional robots which can only perform particular motions by direct input and not by movements of the remote control.

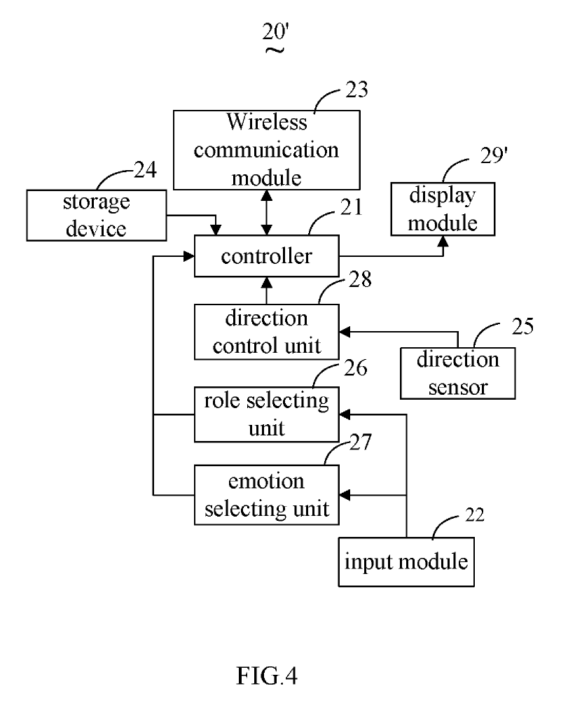

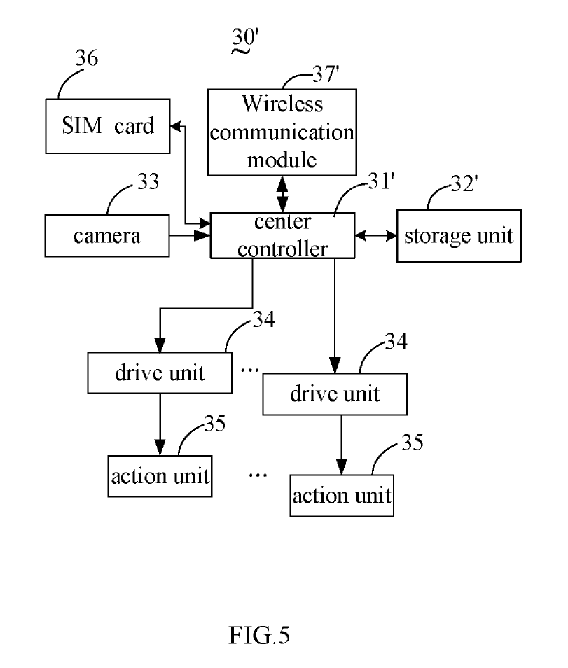

Referring to FIGS. 4 and 5, function block diagrams of a mobile phone 20′ and a robot 30′ in accordance with a second exemplary embodiment are illustrated. The mobile phone 20′ is similar to the mobile phone 20, and includes an input module 22, a storage device 24, a role selecting unit 26, a display module 29′, and an emotion selecting unit 27.

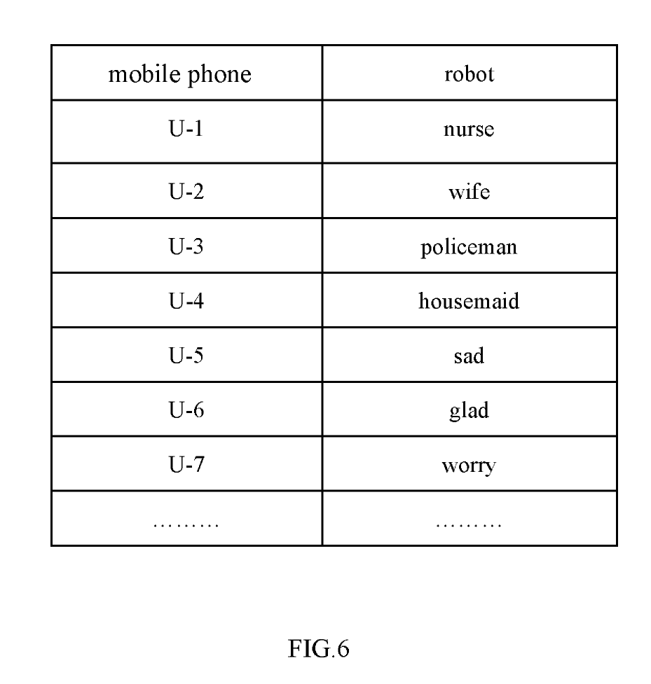

The storage device 24 stores a table containing predetermined roles and predetermined emotion modes. The table may be displayed on a graphical user interface in the display module 29′. As shown in FIG. 6, by way of example, the predetermined roles may be divided into classes that include a policeman, a wife, a nurse, and a housemaid. The emotion modes may include a glad mode, a sad mode, and a worry mode.

The input module 22 refer to herein can be press buttons or rotary buttons. The input module 22 is configured for generating a role selecting signal corresponding to a user's operation for selecting a role from the table. Also, the input module 22 can further generate an emotion selecting signal corresponding to a user's operation for selecting an emotion mode from the table. The role selecting unit 26 is for generating a role changing signal containing the selected role as the tag based on the selecting signal. The emotion selecting unit 27 is for generating an emotion changing signal containing the selected emotion mode based on the emotion selecting signal. The role changing signal and the emotion changing signal may be sent to the robot 30 in short message format or in E-mail format.

The robot 30′ contains a camera 33, a storage unit 32′, a wireless communication 37′, and a centre controller 31′. The storage unit 32′ stores predetermined motion control programs. Each motion control program is associated with a specific tag or tags for being invoked when that tag is received by the center controller 31′ through the wireless communication module 37′. Each motion control program also defines different control parameters which are used to control the motion of one or more action units 35. For example, the motion control program corresponding to tag indicating a role named policeman may define control parameters for controlling one or more action units 35 to complete policeman's tasks, such as patrolling. The motion control program corresponding to tag indicating one of the emotion modes, to do the same task, if the glad mode is selected, the robot 30′ does every thing quickly, if the sad mode is selected, the robot 30′ does every thing slowly.

The center controller 31′ may invoke one motion control program from the storage unit 32′ based on selected role contained in the role changing signal which is received through the wireless communication module 37. The drive units 34 may drive the action units 35 to motion under the control of the motion control program. In other words, the robot 30 may work under the control of the selected role.

The center controller 31 may further invoke one motion control program from the storage unit 32′ based on the selected emotion mode contained in the emotion changing signal which is received through the wireless communication module 37′. The drive units 34 may drive the action units 35 to move under the control of the motion control program. Thus the robot 30′ is endowed with the selected emotion mode.

The camera 33 is configured for capturing images of the surrounding the robot 30 is in. The robot 30′ may send the captured images to the mobile phone 20′ by the multimedia messaging service. Accordingly, the mobile phone 20′ may receive the images and display the captured images in the display module 29. In other words, the users can see images taken from the robot 30 point of view which can make it easier to know how to control the robot 30.

Therefore, the robot 30′ may operate in different roles and is capable of being endowed with different emotions, so that the robot 30′ is very personalizable. It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A robot comprising:
action units for executing motions;
a medium containing an electronic identifier to identify the robot;
a storage unit storing predetermined motion control programs for controlling motions of the action units;
a wireless communication module for receiving a text message from a mobile phone, the text message comprising a tag corresponding to one motion control program;
a center controller for invoking a corresponding one of motion control programs based on the tag; and
drive units for driving the action units to motion under the control of the corresponding motion control program.

2. The robot of claim 1, wherein the text message is in one of a short message format and an E-mail format.

3. The robot of claim 1, wherein the tag indicates a shift quality of the robot, the motion control program corresponding to the tag defines control parameters and the relationship between the control parameters and one or more action units to control the one or more action units to change position or direction of travel of the robot based on the tag.

4. The robot of claim 1, wherein the robot further comprises a camera for capturing images of an environment where the robot locates, and the images are sent to the mobile phone through the wireless communication module.

5. A mobile phone for manipulating a robot, the mobile phone comprising:
a storage device storing an electronic identifier of the robot;
a direction sensor for detecting moving direction of the mobile phone and generating direction data correspondingly;
a direction control unit for changing the direction data into a text message, the direction signal having a tag associated with motion control programs for being executed by the robot based on the tag;
a wireless communication module; and
a controller for receiving the electronic identifier to enable the text message to be transmitted to the robot via the wireless communication module.

6. The mobile phone of claim 5, wherein the text message is in one of a short message format and an E-mail format.

7. The mobile phone of claim 5, wherein the storage device further stores a table comprising predetermined roles, the mobile phone further comprises a display module for displaying the roles on a graphic user interface, an input module for generating a role selecting signal corresponding to an operation of selecting one of the roles, a role selecting unit for generating a text message comprising a tag to indicating that which one of the role is selected.

8. The mobile phone of claim 5, wherein the table further comprises predetermined emotion modes, the mobile phone further comprises a display module for displaying the emotion modes on a graphic user interface, an input module for generating an emotion selecting signal corresponding to an operation of selecting one of the emotion modes, an emotion selecting unit for generating the text message containing the tag to indicating which one of the emotion modes is selected.

9. A robotic system comprising:
a mobile phone comprising a storage device storing an electronic identifier, an input module for generating an input signal in response to an operation on the input unit, a processing unit for generating a text message comprising a tag based on the input signal, and a controller for receiving the electronic identifier to enable the text message to be transmitted;
a robot comprising action units for executing motions, a storage unit for storing predetermined motion control programs for controlling the motion of the action units, a media card containing the electronic identifier to identify the robot, a wireless communication module for receiving the text message from the mobile phone, and drive units for driving the action units, and a center controller, wherein the tag is associated with one of the motion control programs, the center controller invokes a corresponding one of the motion control programs based on the tag, and the drive units for driving the action units to motion under the control of the corresponding motion control program.

10. The robotic system of claim 9, wherein the text message is one of a short message and an E-mail.

11. The robotic system of claim 9, wherein the input module is a direction sensor, the direction sensor is for detecting moving direction of the mobile phone and generating the input signal correspondingly, the processing unit generates the text message containing the tag based on the input signal, wherein the tag indicates shift quality of the mobile phone.

12. The robotic system of claim 11, wherein the motion control program corresponding to the tag defines control parameters and the relationship between the control parameters and one or more action units to control the one or more action units to change position or direction of travel of the robot based on the tag.

13. The robotic system of claim 11, wherein the storage device further stores a table containing predetermined roles, the mobile phone further comprise a display module for displaying the predetermined roles on a graphic user interface, the input module for generating a role selecting signal corresponding to an input of selecting one of the predetermined roles, the processing unit for generating the text message containing the tag to indicate that which role is selected.

14. The robotic system of claim 9, wherein the input module is one of a press button and a rotary button.

15. The robotic system of claim 14, wherein some motion control programs respectively correspond to the predetermined roles, the center controller invokes one corresponding motion control program based on the tag.

16. The robotic system of claim 10, wherein the storage device further stores a table containing predetermined emotion modes, the mobile phone further comprise a display module for displaying the emotion modes on the graphic user interface, the input module for generating an emotion selecting signal corresponding to an input of selecting one of the emotion modes, the processing unit for generating a text message containing the tag to indicate that which one of the emotion modes is selected.

17. The robotic system of claim 16, some motion control programs respectively correspond to the predetermined roles, the center controller invokes one corresponding motion control program based on the tag.

18. The robotic system of claim 10, wherein the robot further comprises a camera for capturing images of the robot surroundings, and the images are sent to the mobile phone through the wireless communication module.
